(19) United States
(12) Patent Application Publication
(10) Pub. No.: US 2004/0151291 A1
(43) Pub. Date: Aug. 5, 2004

(54) Method of managing short messages in facsimile machine of MFP having SMS function

(75) Inventor: Bong-seog Song, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-City (KR)

(21) Appl. No.: 10/625,514

(22) Filed: Jul. 24, 2003

(30) Foreign Application Priority Data
Aug. 16, 2002 (KR) 2002-48397

(51) Int. Cl. H04M 11/00

(52) U.S. Cl. 379/100.01; 379/100.17

(57) ABSTRACT

Managing short messages in a facsimile machine or a multifunctional device having a short message service by setting up a call to a short message service center, receiving SMS short messages from the short message service center, via a modem, and printing the received SMS short messages, so that the SMS messages can be managed in a document format. Further, the received SMS short messages are displayed on a display window, and selectively stored, printed, and deleted.

### CROSS-REFERENCE TO RELATED APPLICATIONS

This application claims the benefit of Korean Application No. 2002-48397, filed Aug. 16, 2002, in the Korean Intellectual Property Office, the disclosure of which is incorporated herein by reference.

### BACKGROUND OF THE INVENTION

1. Field of the Invention

The present invention relates to a facsimile machine or a multifunctional device (MFP) having a short message service (SMS) function, and more particularly, to a method of managing short messages in a facsimile machine or an MFP having an SMS function by which short messages received from a wired network short message service center (SMSC) can be automatically or selectively stored and printed.

2. Description of the Related Art

A short message service (SMS) is a kind of wireless data communication service which transmits short messages using a mobile phone system. Currently, the SMS use is increasing rapidly.

Recently, there have been intensive studies for applying an SMS to a fixed network, such as a public switched telephone network (PSTN)/an integrated service digital network (ISDN), as well as a mobile network. As a result, to provide an SMS via a wired network, ES 201 912 which is a communication protocol stipulating the characteristics of transmissions required between a wired network SMS center (SMSC) and an SMS terminal (SMTE), has been established by the European Telecommunication Standard Institute (ETSI).

However, in a wired telephone having an SMS function, short messages received from an SMSC can be confirmed on a display window attached to the telephone, and the received short messages cannot be printed. Thus, there is a difficulty in managing received SMS short messages.

### SUMMARY OF THE INVENTION

The present invention provides a method of managing short messages in a facsimile machine or a multifunctional device (MFP) having a short message service (SMS) function by which if SMS short messages are received from an SMS center (SMSC) via (by) a transmitter SMS terminal (SMTE), the SMS short messages are displayed on a display window, automatically stored and printed, and thus the short messages can be managed in a document format.

The present invention also provides a method of managing short messages in a facsimile machine or a multifunctional device (MFP) having a short message service (SMS) function by which if SMS short messages are received from an SMS center (SMSC) via (by) a transmitter SMS terminal (SMTE), the SMS short messages are displayed on a display window, selectively stored, printed and deleted, such that an area occupied by the SMS short messages in a memory unit can be minimized, a waste of resources can be eliminated and the SMS short messages can be managed in a document format.

Additional aspects and advantages of the invention will be set forth in part in the description which follows and, in part, will be obvious from the description, or may be learned by practice of the invention.

The present invention may be achieved by a method of managing short messages in a facsimile machine or a multifunctional device having a short message service, the method comprising setting up a call to a short message service center; receiving SMS short messages from the short message service center, via a modem; and printing the received SMS short messages.

According to an aspect of the invention, the method further comprises displaying the received SMS short messages on an operation panel before the printing.

According to an aspect of the invention, the method further comprises storing the displayed SMS short messages in a predetermined memory region according to a user selection or automatically.

According to an aspect of the invention, the method further comprises deleting the printed SMS short messages according to a user selection.

According to an aspect of the invention, the printing comprises determining whether to print the stored SMS short messages; and if determined to print the stored SMS short messages, printing the stored SMS short messages.

According to an aspect of the invention, the printing comprises determining whether to print the stored SMS short messages; if determined to print the stored SMS short messages, displaying a list of the stored SMS short messages; and printing the stored short messages selected by a user from the displayed list of the SMS short messages.

### BRIEF DESCRIPTION OF THE DRAWINGS

The above and/or other aspects and advantages of the invention will become apparent and more readily appreciated from the following description of the embodiments taken in conjunction with the accompanying drawings in which:

FIG. 1 is a structure diagram of a short message service (SMS) system on a local wired network, according to an embodiment of the present invention;

FIGS. 2A and 2B are structure diagrams of an SMS protocol layer and a data link layer of the SMS protocol layer, respectively;

FIG. 3 is a flowchart of managing short messages in a facsimile machine or a multifunctional device (MFP) having a short message service (SMS) function, according to a first embodiment of the present invention;

FIGS. 4A and 4B are flowcharts of managing short messages in a facsimile machine or a multifunctional device (MFP) having a short message service (SMS) function, according to a second embodiment of the present invention; and

FIG. 5 is a flowchart of managing short messages in a facsimile machine or a multifunctional device (MFP) having a short message service (SMS) function, according to a third embodiment of the present invention.

### DETAILED DESCRIPTION OF THE PREFERRED EMBODIMENTS

Reference will now be made in detail to the present embodiments of the present invention, examples of which are illustrated in the accompanying drawings, wherein like reference numerals refer to the like elements throughout. The embodiments are described below to explain the present invention by referring to the figures.

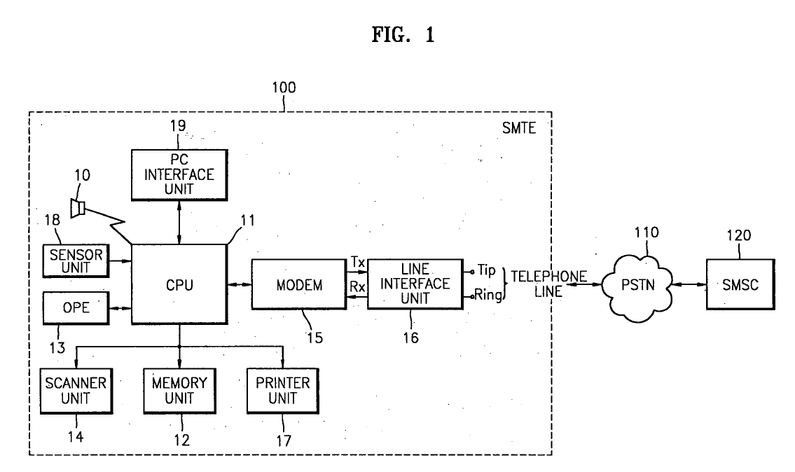

FIG. 1 is a structure diagram of a short message service (SMS) system on a local wired network, according to an embodiment of the present invention. The SMS system comprises a facsimile machine 100 which is an example of an SMS terminal (SMTE), a public switched telephone network (PSTN) 110 which is a wired network including an exchange station, and a short message service center (SMSC) 120.

Typically, the facsimile machine 100 comprises a speaker 10, a central processing unit (CPU) 11, a memory unit 12, an operation panel 13 (OPE), a scanner unit 14, a modem 15, a line interface unit 16, a printer unit 17, a sensor unit 18, and a PC interface unit 19. Further, the facsimile machine 100 has requirements for a terminal stipulated according to a communication protocol for a wired network SMS, e.g., ES 201 912.

The speaker 10 generates. status information of the CPU 11 or an alarm in response to a control signal corresponding to the alarm. The CPU 11 controls the SMS system according to a predetermined program. The memory 12 stores program data, protocol data, and character data, and accesses or stores data according to a control given by the CPU 11. The OPE 13 comprises a plurality of keys with which key data of the SMS system can be generated. For example, the keys relevant to the SMS input key data into the CPU 11 for processing. The OPE 13 further comprises a display window on which display data of the CPU 11 can be displayed. The scanner unit 14 scans a manuscript, converts an image for the manuscript into digital image data, and provides the digital image data to the CPU 11. The modem 15 modulates a signal output from the CPU 11 into an analog signal, outputs the analog signal, demodulates an analog input signal, and outputs the analog input signal according to a control given by the CPU 11. The line interface unit 16 operates according to a control given by the CPU 11, forms a calling loop for the PSTN 110, interfaces the modem 15 with a signal output from the PSTN 110, and interfaces signals output from the modem 15 to the PSTN 110. The printer unit 17 prints scan data or reception data stored in the memory unit 12 according to a control given by the CPU 11. The sensor unit 18 senses the remaining amount of a recording sheet or a manuscript and provides the sensed remaining amount of the recording sheet or the manuscript to the CPU 11. The PC interface unit 19 interfaces to a PC to perform a printing or a scanning operation.

The above-described elements are typical, and similar to elements of a common facsimile machine. Since, typically, short messages are only transmitted via the PSTN 110 with a 1200 baud frequency shift keying (FSK) modulation, a transmission speed of the modem 15 has to be over 1200 bits per second (bps). In addition, typically, an SMS program is stored in the memory unit 12 and if a key indicative of an SMS reception and transmission is input into the OPE 13, the CPU 11 accesses the SMS program stored in the memory unit 12 to confirm received short messages or to write and send short messages. In addition, the facsimile machine 100 is connected to an exchange station (not shown) via the PSTN 110, and the exchange station is connected to the SMSC 120. The SMSC 120 provides the short message service (SMS), such as message reception, message management, and message transmission.

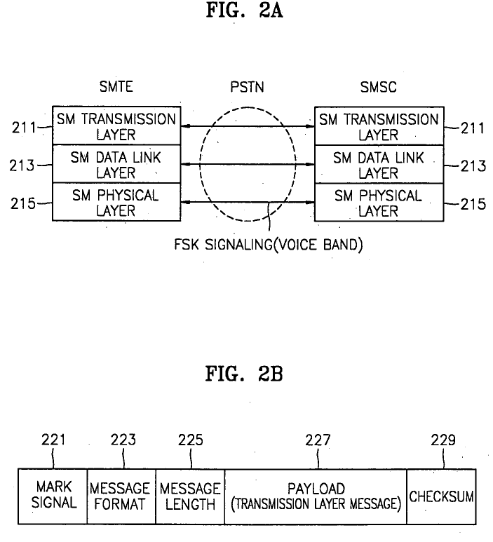

FIG. 2A is a diagram of SMS protocol layers for a wired network, e.g., ES 201 912, employed in the present invention. The SMS protocol layers on a wired network comprise an SMS transmission layer 211, an SM data link layer 213, and an SM physical layer 215. The SMS transmission layer 211 defines various messages and parameters for short message transmission/reception, and the SM data link layer 213 defines mark signals and checksums for reliable transmission/reception between the SMTE (e.g., the facsimile machine 100) and the SMSC 120, and the SM physical layer 215 defines 1200 baud FSK modulation at a voice band.

FIG. 2B is a format diagram of an SMS multiple data message (MDMF) used in the SM data link layer 213 of FIG. 2A. A mark signal 221 used to prepare reception of a message frame, a message format word 223 and a message length word 225 with which connected messages can be confirmed, are added to a front end of a payload word 227 (a transmission layer message), and a checksum word 229 for error detection is added to a rear end of the payload word 227, thereby generating a message frame on the SM data link layer 213. Meanwhile, the transmission layer message 227 comprises a time parameter, a receiver parameter, a password parameter, a circuit number parameter, and a short message parameter (not shown). Each parameter comprises a parameter type, a parameter length, and one or more parameter words.

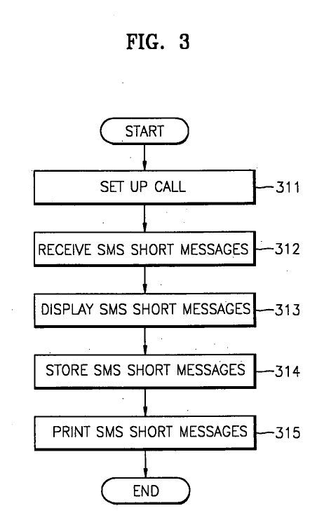

FIG. 3 is a flowchart of managing short messages in a facsimile machine or a multifunctional device (MFP) having a short message service (SMS) function, according to a first embodiment of the present invention. The method comprises, at operation 311, setting up a call, at operation 312, receiving short messages, at operation 313, displaying the short messages, at operation 314, storing the short messages, and, at operation 315, printing the short messages.

The above-described method of managing short messages as shown in FIG. 3 will be described in association with the SMS system shown in FIG. 1. In operation 311, the SMSC 120 receives short messages transmitted from a transmitter SMS terminal (not shown) to which a call is set up via the PSTN 110, and the SMSC 120 stores the short messages. After that, the SMSC 120 sets up a call to a receiver SMS terminal 100 designated by the transmitter SMS terminal. Here, a facsimile machine, a multifunctional device (MFP), or a telephone machine having an SMS function may be used as a transmitter SMS terminal, and a facsimile machine or a MFP having an SMS function and a printing function may be used as the receiver SMS terminal 100.

In operation 312, the receiver SMS terminal 100 interprets a calling party number received from the SMSC 120, identifies a call for receiving SMS short messages from an SMSC number contained in the calling party number, and receives the SMS short messages via the modem 15. In this case, at least one or more SMSC numbers are recorded in the memory unit 12. Thus, if the SMSC number included in the calling party number exists in the SMSC numbers recorded in the memory unit 12, the receiver SMS terminal 100 can identify the call for receiving SMS short messages.

In operation 313, the receiver SMS terminal 100 displays the received SMS short messages on a display window of the OPE 13, and in operation 314, the receiver SMS terminal 100 stores the SMS short messages in a predetermined address of the memory unit 12 by tabling a sequence and the contents of the messages. In operation 315, if storage of the SMS short messages is completed in operation 314, the receiver SMS terminal 100 automatically prints the SMS short messages received in operation 312 via the printer unit 17. According to an aspect of the invention, operation 314 may be selectively performed after operation 313 or 315. If operation 314 is not performed after operation 313 or 315, in operation 313, the receiver SMS terminal 100 displays the received SMS short messages on the display window of the OPE 13 for a predetermined amount of time, and in operation 315, the receiver SMS terminal 100 automatically prints the.SMS short messages received in operation 312 via the printer unit 17. In addition, according to an aspect of the invention, operation 313 may be selectively performed. If operation 313 is not performed, in operations 314 and 315, the receiver SMS terminal 100 stores the SMS short messages received in operation 312 in the predetermined address of the memory unit 12 and automatically prints the SMS short messages via the printer unit 17, or in operation 315, the receiver SMS terminal 100 automatically prints the SMS short messages received in operation 312 via the printer unit 17 without storing the SMS short messages in operation 314.

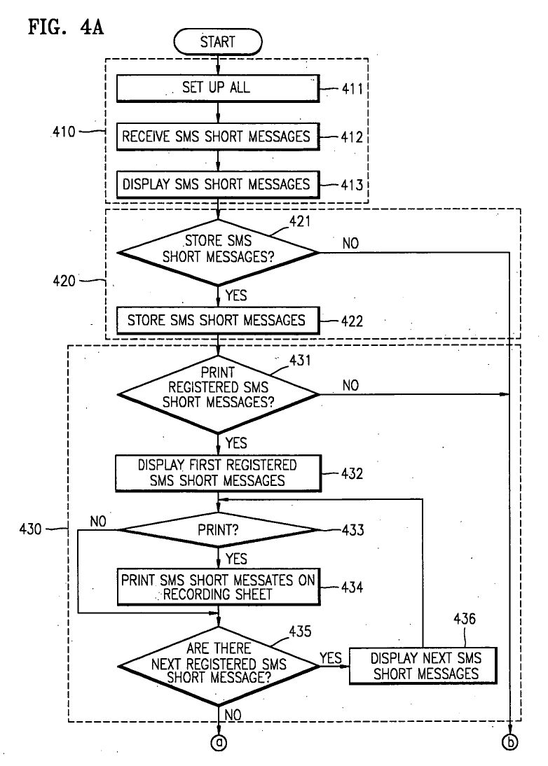

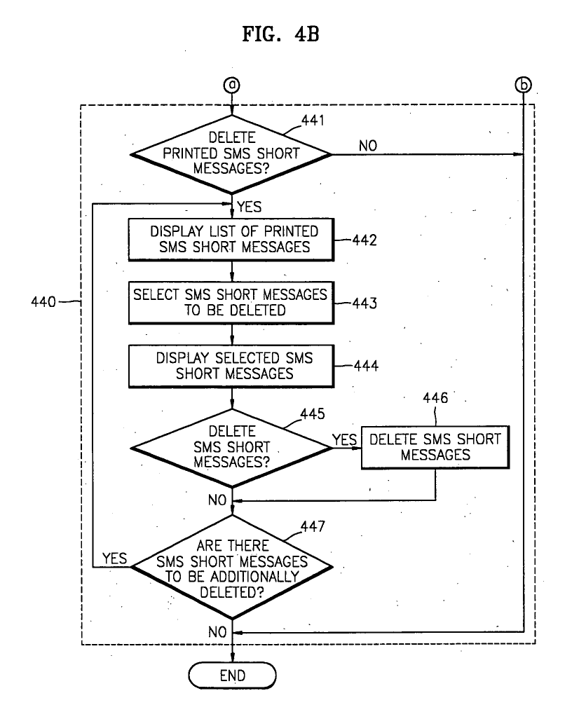

According to an aspect of the invention, the above-described method as shown in FIG. 3 may further comprise deleting the SMS short messages printed in operation 315 automatically or according to a user selection. In particular, FIGS. 4A and 4B are flowcharts of managing short messages in a facsimile machine or a multifunctional device (MFP) having a short message service (SMS) function, according to a second embodiment of the present invention. The method comprises, at operation 410, receiving short messages, at operation 420, storing the short messages, at operation 430, printing the short messages, and, at operation 440, deleting the short messages (440).

The above-described method of managing short messages as shown in FIGS. 4A and 4B will be described in association with the SMS system shown in FIG. 1. In FIG. 4A, operations 411 through 413 of receiving short messages (i.e., operation 410) are the same as operations 311 through 313 described in the first embodiment as shown in FIG. 3, and thus, descriptions thereof will be omitted.

As part of operation 420 storing the short messages, in operation 421, it is determined whether to store the SMS short messages displayed in operation 413. If, at operation 421, a key indicative of a storage instruction is hit on the OPE 13 according to the user's selection, in operation 422, a sequence and the contents of the short messages are tabled and stored in a predetermined address of the memory unit 12. Meanwhile, if in operation 421, the user determines that the displayed SMS short messages are unnecessary and decides not to store the displayed SMS short messages in the memory unit 12, the above-described SMS short message processing ends is terminated (e.g., the displayed SMS short messages are discarded). Accordingly, if the SMS short messages are received and displayed, it is determined whether to store the SMS short messages and if determined not to store the SMS short messages, the SMS short message processing is terminated, or if determined to store the received SMS short messages, a printing operation may be performed on desired short messages, and then SMS short messages may be selectively deleted.

As part of operation 430 printing the short messages, in operation 431, it is determined whether to print the SMS short messages stored and registered in the memory unit 12. If, at operation 431, a key indicative of printing instruction is hit on the OPE 13 according to the user's selection, in operation 432, the contents of the first SMS short messages stored in an ascending or a descending order in the memory unit 12 are displayed on a display window of the OPE 13. Meanwhile, if, at operation 431, the user decides not to print the stored SMS short messages, the SMS short message processing is terminated.

In operation 433, it is determined whether to print any of the displayed SMS short messages. If, at operation 433, a key indicative of a printing instruction is hit on the OPE 13 according to the user's selection, in operation 434, the printer unit 17 is controlled, and printing of the SMS short messages is performed on a predetermined recording sheet. Meanwhile, if, at operation 433, the user decides not to print the displayed SMS short messages, the method proceeds to operation 435. In operation 435, it is determined whether there are next SMS short messages stored and registered in the memory unit 12. If determined in operation 435 that there are next SMS short messages stored and registered in the memory unit 12, the next SMS short messages are displayed on the display window of the OPE 13, and the method returns to operation 433 to repeat operation 433 and subsequent operations related to printing the next SMS short messages. Meanwhile, if determined in operation 435 that there are no next SMS short messages stored and registered in the memory unit 12, the method proceeds to operation 440 of deleting the short messages, which is to be additionally performed.

Operation 440 of deleting the short messages may be performed by deleting the SMS short messages printed in operation 43b or by deleting the SMS short messages stored and registered in operation 420 but not printed at operation 430 (not shown in FIG. 4A), so as to minimize an area occupied by the SMS short messages in the memory unit 12. Here, the former case will be described. In operation 441, it is determined whether to delete the printed SMS short messages. If determined in operation 441 to delete the printed SMS short messages, in operation 442, a list of the printed SMS short messages is displayed on the display window of the OPE 13. In operation 443, the user selects SMS short messages to be deleted from the list of the displayed SMS short messages, and in operation 444, the selected SMS short messages are displayed on the display window of the OPE 13. Meanwhile, if, at operation 441, the user decides not to delete the printed SMS short messages, the above-described SMS short message processing is terminated.

In operation 445, it is determined whether to delete the displayed SMS short messages. If, at operation 445, a key indicative of a deletion instruction is hit on the OPE 13 according to the user's selection, in operation 446, the SMS short messages are deleted. If, at operation 445, the user decides not to delete the SMS short messages, in operation 447, it is determined whether there are additional SMS short messages to be deleted. If, at operation 447, it is determined that there are additional SMS short messages to be deleted, the method returns to operation 442 to repeat operation 442 and subsequent operations, and if, at operation 447, it is determined that there are no additional SMS short messages to be deleted, the above-described SMS short message processing is terminated.

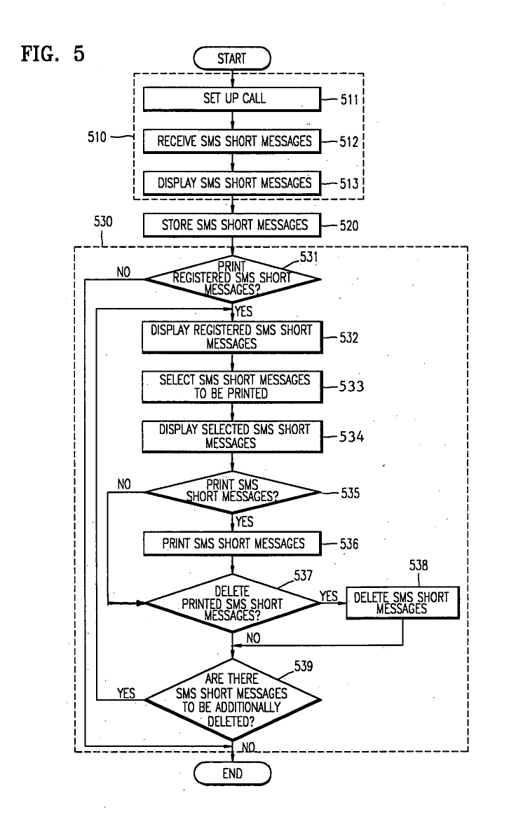

FIG. 5 is a flowchart of managing short messages in a facsimile machine or a multifunctional device (MFP) having a short message service (SMS) function, according to a third embodiment of the present invention. The method comprises, at operation 510, receiving short messages, at operation 520, storing the short messages, and, at operation 530, printing the short messages.

The above-described method of managing short messages as shown in FIG. 5 will be described in association with the SMS system shown in FIG. 1. Like the second embodiment, operations 511 through 513 of receiving and displaying short messages are the same as operations 311 through 313 described in the first embodiment of FIG. 3, and thus, descriptions thereof will be omitted.

In operation 520 of storing the short messages, the displayed SMS short messages are stored in a predetermined address of the memory unit 12 by tabling a sequence and the contents of the short messages. According to an aspect of the present invention, operation 520 of storing the short messages may further comprise determining whether to store the SMS short messages like in the second embodiment and may be performed by storing the SMS short messages in the memory unit 12 according to the user's selection or by displaying the SMS short messages and then discarding the SMS short messages. That is, like in the second embodiment, if the SMS short messages are received and displayed, it is determined whether to store the SMS short messages. If it is decided not to store the SMS short messages, the above-described SMS short message processing is terminated (e.g., the displayed SMS short messages are discarded). Otherwise, if determined to store the received SMS short messages, the received SMS short messages are displayed and stored, and a printing operation may be performed on desired stored SMS short messages. After the printing, the SMS short messages may be selectively deleted.

As part of operation 530 printing the short messages, in operation 531, it is determined whether to print the SMS short messages stored and registered in the memory unit 12. If, at operation 531, a key indicative of a printing instruction is hit on the OPE 13 according to the user's selection, in operation 532, a list of the SMS short messages stored and registered in the memory unit 12 is displayed on a display window of the OPE 13. Meanwhile, if, at operation 531, the user decides not to print the stored SMS short messages, the above-described SMS short message processing is terminated.

In operation 533, the user selects SMS short messages to be printed from the list of the displayed SMS short messages. In operation 534, the selected SMS short messages are displayed on the display window of the OPE 13. In operation 535, it is determined whether to print the displayed SMS short messages. If, at operation 535, a key indicative of a printing instruction is hit on the OPE 13 according to the user's selection, in operation 536, the printer unit 17 is controlled, and printing of the SMS short messages is performed on a predetermined recording sheet. Meanwhile, if, at operation 535, the user decides not to print the displayed SMS short messages, the method proceeds to operation 537 of deleting the short messages, which is to be additionally performed.

In operation 537, it is determined whether to delete the SMS short messages printed in operation 536. If, at operation 537, a key indicative of a deletion instruction is hit on the OPE 13 according to the user's selection, in operation 538, the SMS short messages are deleted. If, at operation 537, the user decides not to delete the printed SMS short messages, the method proceeds to operation 539. In operation 539, it is determined whether there are additional SMS short messages to be printed. If determined in operation 539 that there are additional SMS short messages to be printed, the method returns to operation 532. If determined in operation 539 that there are no additional SMS short messages to be printed, the above-described SMS short message processing is terminated.

Typically, the above-mentioned embodiments of the present invention may be implemented as a computer program. The program is stored in computer readable media and is read and executed by a computer (i.e., the CPU 11). More particularly, the processes of invention as implemented in software are embodied in a computing apparatus, such as computer, facsimile machine, a multifunction device, printer, etc. Suitable computer readable media include magnetic recording media, such as ROMs, floppy disks, or hard disks, optical recording media, such as CD ROMs or DVDs, and carrier waves, such as transmission via the Internet.

As described above, according to the present invention, if SMS short messages are received from an SMS center (SMSC) via a transmitter SMS terminal (SMTE) in a facsimile machine or a multifunctional device (MFP) having a short message service (SMS) function, the SMS short messages are displayed on a display window, automatically stored and printed, and thus can be managed in a document format, so a user can manage the SMS short messages conveniently.

According to an aspect of the invention, if SMS short messages are received from an SMS center (SMSC) via a transmitter SMS terminal (SMTE) in a facsimile machine or a multifunctional device (MFP) having a short message service (SMS) function, the SMS short messages are displayed on a display window, whether the SMS short messages are stored is determined, whether the stored and registered SMS short messages are printed in the order of a descending series or an ascending series is sequentially determined, and the SMS short messages are printed. According to an aspect of the invention, it is determined whether to delete the printed SMS short messages, and the SMS short messages are deleted, such that an area occupied by the SMS short messages in the memory unit can be minimized, a waste of resources can be eliminated and the user can manage the SMS short messages conveniently.

Therefore, the present invention provides a SMS short message printing apparatus, comprising a programmed computer processor setting up a call to a short message service center, receiving SMS short messages from the short message service center, via a modem, and printing the received SMS short messages, so that the SMS messages can be managed in a document format. Further, the programmed computer processor displays the received SMS short messages on a display window, and allows selective storage, print, and deletion of the received SMS short messages via input commands.

While this invention has been particularly shown and described with reference to a few embodiments thereof, it will be understood by those skilled in the art that various changes in form and details may be made therein without departing from the spirit and scope of the invention as defined by the appended claims and equivalents thereof.

What is claimed is:

1. A method of managing short messages in a facsimile machine or a multifunctional device having a short message service, the method comprising:
setting up a call to a short message service (SMS) center;
receiving the SMS short messages from the short message service center, via a modem; and
printing the received SMS short messages.

2. The method of claim 1, further comprising displaying the received SMS short messages on an operation panel before the printing.

3. The method of claim 1, further comprising storing the received SMS short messages in a predetermined memory region according to a user selection or automatically before the printing.

4. The method of claim 2, further comprising storing the displayed SMS short messages in a predetermined memory region according to a user selection or automatically before the printing.

5. The method of claim 1, further comprising storing the printed SMS short messages in a predetermined memory region according to a user selection or automatically after the printing.

6. The method of claim 2, further comprising storing the printed SMS short messages in a predetermined memory region according to a user selection or automatically after the printing.

7. The method of claim 3, further comprising deleting the printed SMS short messages according to a user selection.

8. The method of claim 4, further comprising deleting the printed SMS short messages according to a user selection.

9. The method of claim 5, further comprising deleting the printed SMS short messages according to a user selection.

10. The method of claim 6, further comprising deleting the printed SMS short messages according to a user selection.

11. The method of claim 3, wherein the printing comprises:
determining whether to print the stored SMS short messages; and
if determined to print the stored SMS short messages, printing the stored SMS short messages.

12. The method of claim 3, wherein the printing comprises:
determining whether to print the stored SMS short messages;
if determined to print the stored SMS short messages, displaying a list of the stored SMS short messages; and
printing the stored SMS short messages selected by a user from the displayed list of the SMS short messages.

13. A method of managing short messages in a facsimile machine or a multifunctional device having a short message service, the method comprising:
setting up a call to a short message service (SMS) center;
receiving the SMS short messages from the short message service center, via a modem;
displaying the received SMS short messages on an operation panel;
storing the received SMS short messages in a predetermined memory region; and
printing the stored SMS short messages.

14. The method of claim 13, wherein the printing comprises:
determining whether to print the stored SMS short messages; and
if determined to print the SMS short messages, printing the stored SMS short messages.

15. The method of claim 13, wherein printing comprises:
determining whether to print the stored SMS short messages;
if determined to print the stored SMS short messages, displaying a list of the stored SMS short messages; and
printing short messages selected by a user from the displayed list of the SMS short messages.

16. The method of claim 13, further comprising deleting the stored printed SMS short messages according to a user selection.

17. The method of claim 14, further comprising deleting the stored printed SMS short messages according to a user selection.

18. The method of claim 15, further comprising deleting the stored printed SMS short messages according to the user selection.

19. A computer readable recording medium storing a program controlling a computer according to the method of claim 1.

20. A computer readable recording medium storing a program controlling a computer according to the method of claim 13.

21. A short message service (SMS) printing apparatus, comprising a programmed computer processor setting up a call to the SMS, receiving short messages from the SMS, and printing the received SMS short messages.

22. The apparatus of claim 21, wherein the programmed computer processor provides the received SMS short messages, and allows selective storage, print, and deletion of the received SMS short messages via input commands.

23. A short message service (SMS) printing apparatus, comprising:
an SMS interface receiving short messages from the SMS; and
a printer automatically printing the received SMS short messages.

24. The apparatus of claim 23, further comprising:
a display unit displaying the received SMS short messages; and
an input unit receiving a user selection to print a displayed SMS short message by the printer.

25. The apparatus of claim 24, wherein the display unit displays the SMS short messages in an ascending or a descending order, and the input unit sequentially receives the user selection to print the displayed SMS short messages.

26. The apparatus of claim 24, further comprising:
a storage storing the received SMS short messages, wherein the input unit receives another user selection to delete the printed SMS short message from the storage.

27. A printing device having a short message service (SMS) function, comprising:
a programmed computer processor setting up a call to an SMS center, receiving and storing SMS short messages from the SMS center, selectably providing the received SMS short messages, and printing the SMS messages according to a selection to allow managing the received SMS short messages in a document format.

28. A method, comprising:
managing received short message service (SMS) short messages in a document format by selectively printing the received SMS messages.
